(19) United States
(12) Patent Application Publication
(10) Pub. No.: US 2005/0234712 A1
(43) Pub. Date: Oct. 20, 2005

(54) Providing shorter uniform frame lengths in dynamic time warping for voice conversion

(76) Inventors: Yongqiang Dong, Beijing (CN); Xiaohua Shi, Beijing (CN); Zhiwei Ying, Beijing (CN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/343,243

(22) PCT Filed: May 28, 2001
(86) PCT No.: PCT/CN01/00877

§ 371 Date: May 5, 2005

(51) Int. Cl. G10L 11/04

(52) U.S. Cl. 704/207; 704/216

(57) ABSTRACT

A method and apparatus for frame matching is disclosed. The frame matching includes receiving numbers of frames in first and second input signals within a voice unit. A uniform frame length of the first input signal is then updated to a time sample period of the first input signal divided by the number of frames in the second input signal, when the number of frames in the second input signal is greater than or equal to the number of frames in the first input signal. Otherwise, a uniform frame length of the second input signal is updated to a time sample period of the second input signal divided by the number of frames in the first input signal.

### BACKGROUND

The present disclosure relates to voice conversion using dynamic time warping, and more particularly, to using shorter uniform frame lengths in dynamic time warping. Consequently for purposes of illustration and not for purposes of limitation, the exemplary embodiments of the invention are described in a manner consistent with such use, though clearly the invention is not so limited.

In voice conversion, an acoustic feature of speech, such as, for example, its spectral profile or average pitch, may be analyzed to represent it as a sequence of numbers. The feature may then be modified from the source speaker's voice in accordance with statistical properties of a target speaker's voice. A typical voice converter may have a reference vocabulary stored as acoustic patterns called templates. An input utterance may be converted to digital form and compared to the reference templates. The most similar template is selected as the identity of the input.

In order to compare an input pattern, e.g. a spoken word, with a reference, each word is divided into a sequence of time frames. In each time frame, signals representative of acoustic features of the speech pattern are obtained. For each frame of the input word, a frame of the reference word is selected. Signals representative of the similarity or correspondence between each selected pair of frames are obtained responsive to the acoustic feature signals. The correspondence signals for the sequence of input and reference word frame pairs are used to obtain a signal representative of the global or overall similarity between the input word and a reference word template.

Since there are many different ways of pronouncing the same word, the displacement in time of the acoustic features comprising the word is variable. Different utterances of the same word, even by the same individual, may be widely out of time alignment. The selection of frame pairs is therefore not necessarily linear. Matching, for example, the fourth, fifth and sixth frames of the input utterance with the fourth, fifth and sixth frames respectively of the reference word may distort the similarity measure and produce unacceptable errors.

Dynamic time warping (DTW) techniques may be used to align the frames of a test and reference pattern in an efficient manner. The DTW technique is used to cope with a difference in length of utterance according to the individual personalities of the unspecified person. The alignment is efficient in that the global similarity measure assumes an extremum. It may be, for example, that the fifth frame of the test word should be paired with the sixth frame of the reference word to obtain the best similarity measure.

Since the acoustic feature vector is based on short-term quasi-stationary speech signal analysis, the vector needs to be extracted from the speech waveform frame-by-frame. To make sure that the corresponding frames of the source and target speakers' voices contain substantially similar content, the two speakers need to input speech read from substantially similar text. However, experiments have revealed that the DTW technique has difficulty in matching frames when the two voices are substantially different than when they are substantially similar.

### BRIEF DESCRIPTION OF THE DRAWINGS

FIG. 1 illustrates an example process of frame matching using the conventional dynamic time warping (DTW) technique.

FIG. 2 is a block diagram of a speech conversion system in accordance with an embodiment of the present disclosure.

FIG. 3 is a flowchart illustrating a process of generating shorter uniform frame lengths according to an embodiment.

FIG. 4 illustrates an example process of frame matching according to an embodiment.

FIG. 5 is a block diagram of the normalized mean square error (MSE) generator according to an embodiment.

FIG. 6 shows a comparison plot of the normalized mean square errors measured for a Mandarin speech conversion experiment.

### DETAILED DESCRIPTION

In recognition of the above-described difficulties in using the conventional dynamic time warping (DTW) technique, the present disclosure describes a system and method for providing shorter uniform frame lengths for the DTW technique in voice conversion. Thus, the present system of providing shorter frame lengths reinforces the DTW technique when the two voice signals are significantly different. However, the present system should work well for all cases.

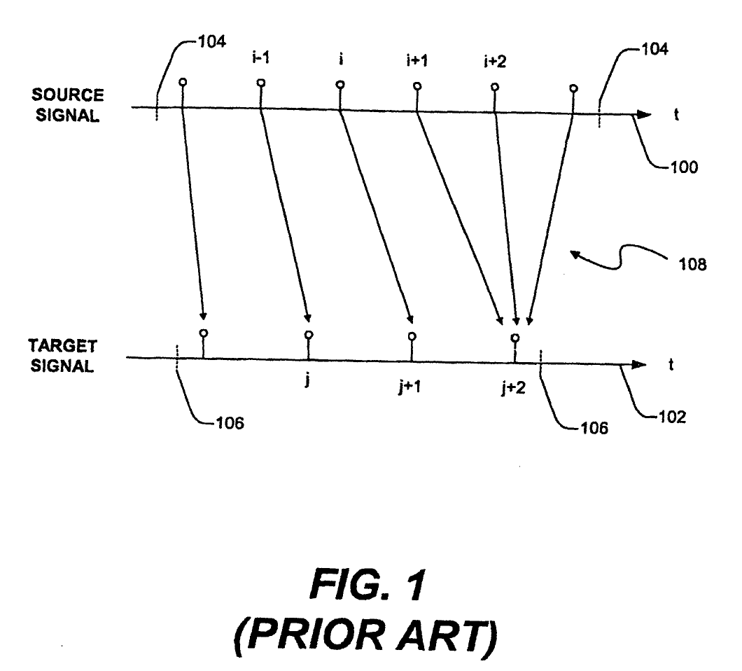

FIG. 1 illustrates an example process of frame matching using the conventional DTW technique. The illustrated process shows pitch marks of both source 100 and target 102 voice signals with uniform frame lengths. The process also shows syllable boundary marks 104, 106 for the source 100 and target 102 signals, respectively.

The source signal 100 is represented as i frames, while the target signal 102 is represented as j frames. For the case where the source voice is substantially similar to the target voice, the i-th frame of the source signal 100 should correspond to the j-th frame of the target signal 102. However, in FIG. 1, the source voice is shown to be substantially different from the target voice. Thus, the DTW technique may erroneously match the i-th frame of the source signal 100 with the (j+1)-th frame of the target signal 102, or even with the (j+2)-th frame. This situation may be comparable to correlating the pronunciation of a letter ‘o’ by a source voice to the pronunciation of a Letter ‘e’ by a target voice. This erroneous correspondence may result in relatively long uniform frame length, as shown in 108. Furthermore, this erroneous correspondence may change the mapping operation, and therefore, introduce artifacts or noise in the converted voice.

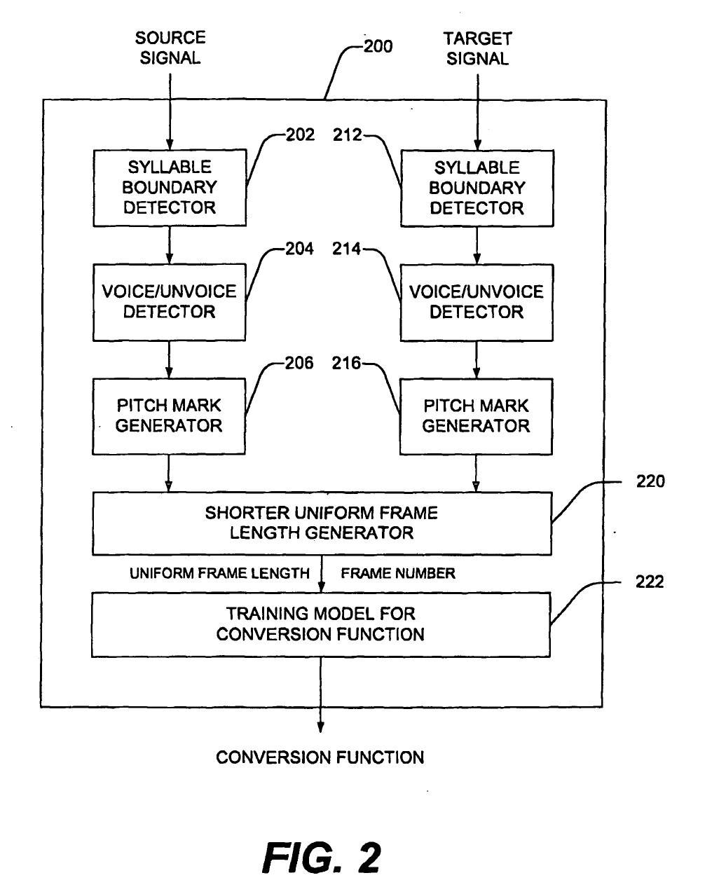

A block diagram of a speech conversion system 200 in accordance with an embodiment of the present disclosure is shown in FIG. 2. The speech conversion system 200 receives source and target voice signals. The system 200 is arranged to convert the source voice signal into a corresponding target voice signal. Therefore, the corresponding target voice signal includes substantially similar speech/text of the source voice signal in target voice.

The speech conversion system 200 includes a frame length generator 220 adapted to provide shorter uniform frame lengths than the frame lengths provided by the conventional DTW technique. The system 200 also includes voice unit boundary detectors 202, 212, voice/unvoice detectors 204, 214, and voice frame mark generators 206, 216. The system 200 further includes a training model 222, which receives the frame number and the uniform frame length for each frame number, and generates a conversion operation.

In the illustrated embodiment of FIG. 2, the voice unit boundary detectors 202, 212 are syllable boundary detectors 202, 212 that receive source or target voice signal, and parse sentences or words into recognizable syllables. Thus in this particular embodiment, the voice unit boundary represents a syllable. However in other embodiments, the voice unit boundary may represent different segment or part of speech.

In an alternative embodiment, the system 200 may include only one each of the voice unit boundary detector 202 voice/unvoice detector 204 and the voice frame mark generator 206. In this particular embodiment, the source and target signals may then be routed or multiplexed through the detectors 202, 204 and the generator 206, sequentially or in parallel.

The voice/unvoice detector 204, 214 segregates the parsed voice unit or syllable into voiced and unvoiced sections. The voice/unvoice segregation is applied to the voice unit to allow the generation of pitch marks or frame marks.

The voice frame mark generator 206, 216 generates these pitch marks or frame marks only on the voiced section of the voice unit. The generator 206, 216, however, may generate any other marks to indicate the voice unit. Typically, the correlated processing duration for the voiced section of the voice unit is approximately between 200 and 400 milliseconds.

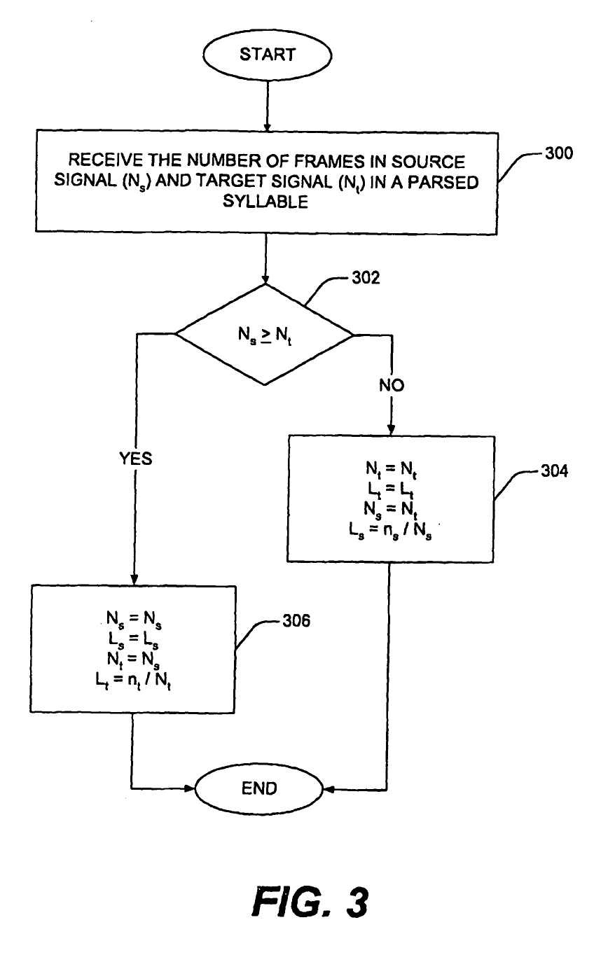

FIG. 3 is a flowchart illustrating a process of generating shorter uniform frame lengths in accordance with an embodiment of the present disclosure. The process may be implemented in the frame length generator 220 of FIG. 2. This process may be programmed as computer software. The process may also be hard-coded in a read-only memory (ROM) or in a logic array.

The illustrated process includes receiving the number of frames in source (Nₛ) and target (Nₜ) signals within a parsed voice unit such as a syllable, at 300. Only the voiced section of the syllable may be processed. At 302, the number of frames in the source signal (Nₛ) is compared to the number of frames in the target signal (Nₜ).

If the number of frames (Nₛ) in the source signal is greater than or equal to the number of frames (Nₜ) in the target signal, the number of frames (Nₛ) and the uniform frame length (Lₛ) of the source signal are unchanged. However, the number of frames (Nₜ) and the uniform frame length (Lₜ) of the target signal are modified, at 306. In the illustrated embodiment, the number of frames (Nₜ) of the target signal is set to the number of frames (Nₛ) in the source signal. Moreover, the uniform frame length (Lₜ) of the target signal is set to the time sample period (nₜ) of the target signal divided by the number of frames (Nₜ) of the target signal.

Otherwise if the number of frames (Nₛ) in the source signal is less than the number of frames (Nₜ) in the target signal, the number of frames (Nₜ) and the uniform frame length (Lₜ) of the target signal are unchanged. However, the number of frames (Nₛ) and the uniform frame length (Lₛ) of the source signal are modified, at 304. In the illustrated embodiment, the number of frames (Nₛ) of the source signal is set to the number of frames (Nₜ) in the target signal. Moreover, the uniform frame length (Lₛ) of the source signal is set to the time sample period (nₛ) of the source signal divided by the number of frames (Nₛ) of the source signal.

Therefore, the above-described process operates to use the larger number for the number of frames in the input signal to obtain the shorter uniform frame length.

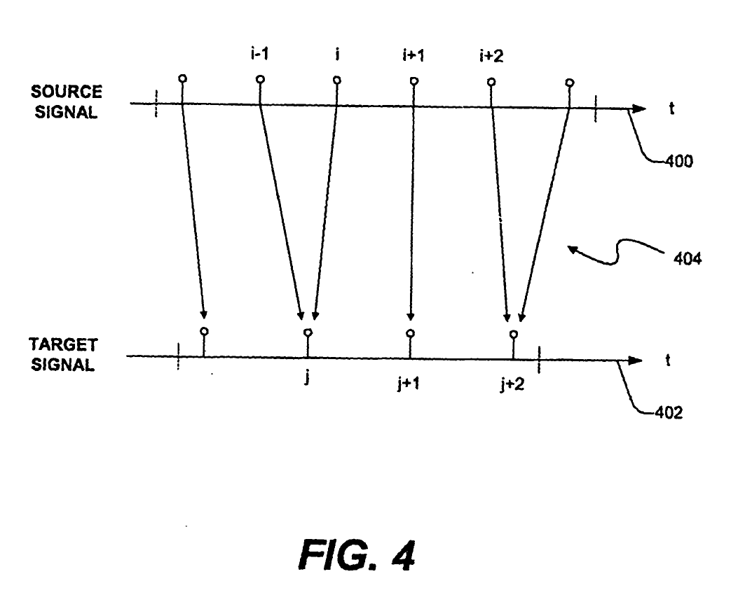

FIG. 4 illustrates an example process of frame matching according to an embodiment of the present disclosure. The process includes using the DTW technique, but enhanced with shorter uniform frame length generation (see FIG. 3). The illustrated process shows voice frame marks of both source 400 and target 402 voice signals with uniform frame lengths, similar to those in FIG. 1. However, the new process illustrates the benefit of using the frame length generator 220. The illustrated frame matching process shows that by using the shorter uniform frame length generation process of FIG. 3, the uniform frame lengths 404 may be significantly shortened.

The effectiveness of the new process, illustrated in FIG. 4, may be measured by comparing the normalized mean square errors (MSE). The MSE of the conventional DTW technique may be compared to the MSE of the new process, after training.

The normalized MSE between the converted training voice and the target training voice may be computed as follows:

$${ɛ}_{MSE} = \frac{\frac{1}{N} {\sum }_{n = 1}^{N} {‖ {y}_{n} - F ( {x}_{n} ) ‖}^{2}}{\frac{1}{N} {\sum }_{n = 1}^{N} {‖ {y}_{n} - {μ}^{y} ‖}^{2}} , \qquad ( 1 )$$

where xₙ and yₙ are the source and target training feature vectors, μ^{y} is the mean of the target training feature vector, and F(.) is the conversion operation. The conversion operation may be chosen so that it corresponds to the mean of the minimum normalized MSE.

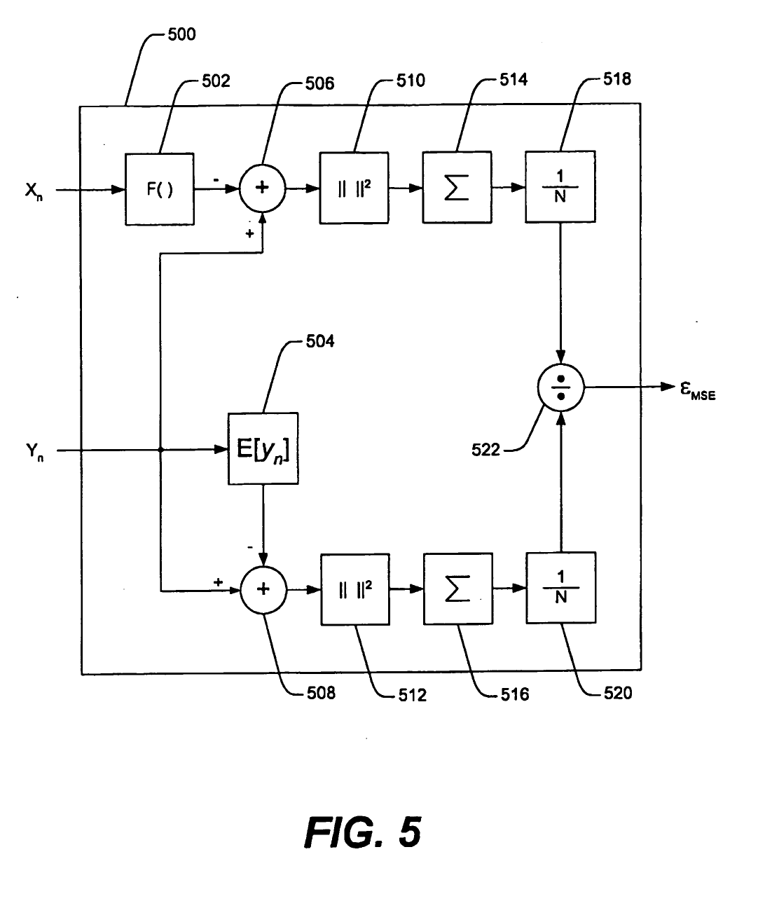

FIG. 5 is a block diagram of the normalized mean square error (MSE) generator 500 according to an embodiment of the present disclosure. The generator 500 includes a conversion operation 502 and a mean operation 504. The generator 500 also includes adders 506, 508, distance calculators 510, 512, summing elements 514, 516, and normalizing elements 518, 520. The generator 500 further includes a divider 522.

The generator 500 receives the source and target training feature vectors, Xₙ and Yₙ, respectively. The feature vectors are then processed, summed, and normalized to produce a mean square error according to equation (1) above. As mentioned above, the normalized MSE generator 500 may be used to measure the effectiveness of the new process illustrated in FIGS. 3 and 4.

In an alternative embodiment, the normalized MSE generator 500 may be used to determine which source signal includes “substantially different” voice from the target signal. If the normalized MSE is large, then the two signals may have substantially different voice. Otherwise if the normalized MSE is small, then the two signals may have substantially similar voice. Therefore in the alternative embodiment, the determination may be used to apply the shorter uniform frame length generation only when the two signals have substantially different voice.

Advantages of the present disclosure may be evaluated both objectively and subjectively. The subjective evaluation may be made by listening to the converted voice, which has noise and other artifacts removed. The shorter uniform frame length generation process, illustrated in FIGS. 3 and 4, provides removal of noise and artifacts. Furthermore, the objective evaluation may be made by measuring the normalized MSE according to equation (1), and as illustrated in FIG. 5.

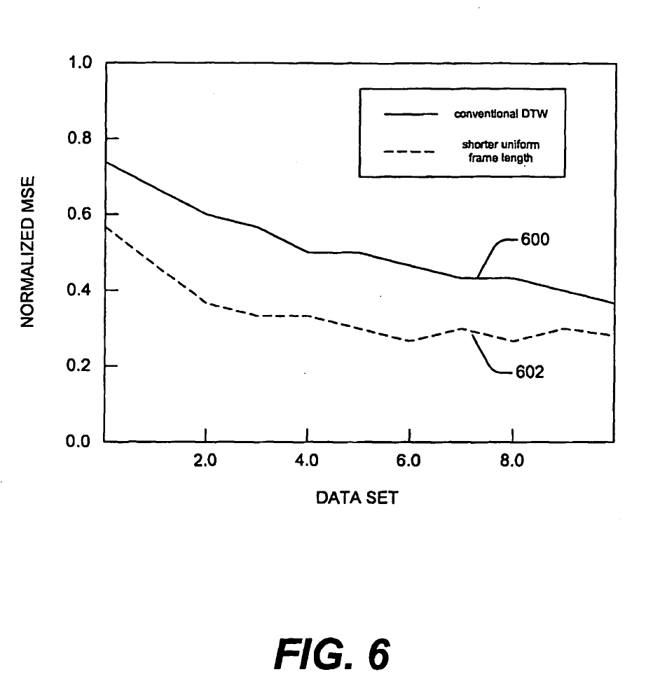

FIG. 6 shows a comparison plot of the normalized mean square errors measured for a Mandarin speech conversion experiment. The experiment was performed to convert female Mandarin voice to male voice. Curve 600 illustrates the measured MSE using the conventional DTW technique. Curve 602 illustrates the measured MSE using the DTW technique enhanced with the shorter uniform frame length generation process. The plot shows that the DTW technique enhanced with the shorter uniform frame length generation process produces consistently smaller mean square error.

While specific embodiments of the invention have been illustrated and described, such descriptions have been for purposes of illustration only and not by way of limitation. Accordingly, throughout this detailed description, for the purposes of explanation, numerous specific details were set forth in order to provide a thorough understanding of the present invention. It will be apparent, however, to one skilled in the art that the system and method may be practiced without some of these specific details. In other instances, well-known structures and functions were not described in elaborate detail in order to avoid obscuring the subject matter of the present invention. Accordingly, the scope and spirit of the invention should be judged in terms of the claims which follow.

1. A method for frame matching, comprising:
receiving numbers of frames in first and second input signals within a voice unit; and
updating a uniform frame length of said first input signal to a time sample period of said first input signal divided by the number of frames in said second input signal, when the number of frames in said second input signal is greater than or equal to the number of frames in said first input signal.

2. The method of claim 1, further comprising:
second updating a uniform frame length of said second input signal to a time sample period of said second input signal divided by the number of frames in said first input signal, when the number of frames in said second input signal is less than the number of frames in said first input signal.

3. The method of claim 2, further comprising:
third updating the number of frames in said first input signal to the number of frames in said second input signal, when the number of frames in said second input signal is greater than or equal to the number of frames in said first input signal; and
fourth updating the number of frames in said second input signal to the number of frames in said first input signal, when the number of frames in said second input signal is less than the number of frames in said first input signal.

4. The method of claim 3, further comprising:
training said first and second input signals with the updated numbers of frames and the updated uniform frame lengths

5. The method of claim 1, wherein said first input signal is a target voice signal, and said second input signal is a source voice signal.

6. The method of claim 1, wherein said voice unit is a syllable.

7. The method of claim 6, wherein said number of frames is a number of pitch marks within a syllable.

8. The method of claim 1, further comprising:
parsing a voice stream of each of said first and second input signals into at least one voice unit.

9. The method of claim 8, further comprising:
segregating each voice unit into voiced and unvoiced sections.

10. The method of claim 9, further comprising:
determining the number of frames in said first and second input signals within the voice unit.

11. A method for frame matching, comprising:
receiving numbers of frames in first and second input signals within a voice unit; and
first updating a uniform frame length of said first input signal to a time sample period of said first input signal divided by the number of frames in said second input signal, when the number of frames in said second input signal is greater than or equal to the number of frames in said first input signal, and otherwise
second updating a uniform frame length of said second input signal to a time sample period of said second input signal divided by the number of frames in said first input signal.

12. The method of claim 11, further comprising:
third updating the number of frames in said first input signal to the number of frames in said second input signal, when the number of frames in said second input signal is greater than or equal to the number of frames in said first input signal; and
fourth updating the number of frames in said second input signal to the number of frames in said first input signal, when the number of frames in said second input signal is less than the number of frames in said first input signal.

13. A computer readable medium containing executable instructions which, when executed in a processing system, causes the system to perform frame matching, comprising:
receiving numbers of frames in first and second input signals within a voice unit; and
updating a uniform frame length of said first input signal to a time sample period of said first input signal divided by the number of frames in said second input signal, when the number of frames in said second input signal is greater than or equal to the number of frames in said first input signal.

14. The computer readable medium of claim 13, further comprising:
second updating a uniform frame length of said second input signal to a time sample period of said second input signal divided by the number of frames in said first input signal, when the number of frames in said second input signal is less than the number of frames in said first input signal.

15. The medium of claim 14, further comprising:
third updating the number of frames in said first input signal to the number of frames in said second input signal, when the number of frames in said second input signal is greater than or equal to the number of frames in said first input signal; and
fourth updating the number of frames in said second input signal to the number of frames in said first input signal, when the number of frames in said second input signal is less than the number of frames in said first input signal.

16. A frame matching system, comprising:
a storage element to receive and store numbers of frames in first and second input signals within a voice unit; and
a processor to update a uniform frame length of said first input signal to a time sample period of said first input signal divided by the number of frames in said second input signal, when the number of frames in said second input signal is greater than or equal to the number of frames in said first input signal, and otherwise to update a uniform frame length of said second input signal to a time sample period of said second input signal divided by the number of frames in said first input signal.

17. The system of claim 16, further comprising:
a voice unit detector to parse a voice stream of each of said first and second input signals into at least one voice unit.

18. The system of claim 17, further comprising:
a voice/unvoice detector to segregate each voice unit into voiced and unvoiced sections.

19. The system of claim 18, further comprising:
a voice frame mark generator to determine the number of frames in said first and second input signals within the voice unit.

20. A system, comprising:
a receiving element to receive and store source and target training feature vectors; and
a processor to compute mean square error between converted voice of said source training feature vector and said target training feature vector, where said mean square error provides a quality measure of the converted voice.

21. The system of claim 20, wherein said processor includes:
a conversion operation element to receive said source training feature vector, and to generate a conversion operation of said source vector;
a first adder to subtract the conversion operation from said target training feature vector, and to generate a first vector;
a mean operation generator to generate a mean of the target training feature vector;
a second adder to subtract the mean from the target training feature vector, and to generate a second vector;
a first distance calculator to compute a square distance of the first vector, and to generate a third vector;
a second distance calculator to compute a square distance of the second vector, and to generate a fourth vector;
a first summing element to sum elements in the third vector, and to generate a fifth vector;
a second summing element to sum elements in the fourth vector, and to generate a sixth vector; and
a divider to divide the fifth vector by the sixth vector, and to generate the mean square error.

22. The system of claim 21, further comprising:
a first normalizing element to divide the fifth vector by a first normalizing value; and
a second normalizing element to divide the sixth vector by a second normalizing value.

23. A method, comprising:
computing mean square error between converted voice of a source training feature vector and a target training feature vector, where the mean square error provides a quality measure of the converted voice.

24. The method of claim 23, wherein said mean square error is computed as
$${ɛ}_{MSE} = \frac{\frac{1}{N} {\sum }_{n = 1}^{N} {‖ {y}_{n} - F ( {x}_{n} ) ‖}^{2}}{\frac{1}{N} {\sum }_{n = 1}^{N} {‖ {y}_{n} - {μ}^{y} ‖}^{2}} ,$$
where xₙ and yₙ are the source and target training feature vectors, μ^{y} is a mean of the target training feature vector, and F(.) is a conversion operation.
